(19) United States
(12) Patent Application Publication
(10) Pub. No.: US 2010/0253063 A1
(43) Pub. Date: Oct. 7, 2010

(54) INSTANT WIN LOTTERY TICKET WITH FULL COLOUR SECURITY AREA AND METHOD OF MANUFACTURE

(75) Inventor: Aapo Mauri Kustaa Skogster, Vancouver (CA)

Correspondence Address: KLARQUIST SPARKMAN, LLP, 121 SW SALMON STREET, SUITE 1600, PORTLAND, OR, 97204, US

(73) Assignee: Black & White Paper MFG. AB

(21) Appl. No.: 12/742,620

(22) PCT Filed: Nov. 13, 2008
(86) PCT No.: PCT/CA2008/001992

§ 371 Date: May 12, 2010

Related U.S. Application Data
(60) Provisional application No. 60/996,323, filed on Nov. 13, 2007.

(51) Int. Cl. B42D 15/00; B41F 33/00

(52) U.S. Cl. 283/100; 101/483

(57) ABSTRACT

A scratch-off instant game card and method of manufacture provides a substrate having a secure area with full colour variable images printed on the secure area comprising information which is variable between cards. The image is printed using a digital printing method capable of printing variable images including the liquid electro-photographic printing method, the toner electro-photographic printing method, the continuous inkjet printing method and the drop on demand inkjet printing method. The substrate for the security area comprises sufficient absorptive qualities to enable a rapid and high level of adhesion of the image to the security area and being sufficiently impenetrable to prevent determination of the contents of the image through the substrate. Two varnish layers and two scratch-off layers cover the graphical image.

### CROSS REFERENCES TO RELATED APPLICATIONS

This application claims the benefit of U.S. Provisional Application No. 60/996,323, filed Nov. 13, 2007 the contents of which are hereby incorporated by reference in their entirety.

### BACKGROUND OF THE INVENTION

This invention relates to instant scratch off lottery tickets and similar products such as cards, prepaid cards, vouchers and coupons in which a security area containing play or validation information is securely hidden from view until a scratch-off layer is removed. More particularly this invention relates to these types of products in which a full colour image is printed in the security area and remain securely hidden until the scratch-off layer is removed.

Instant Scratch-off lottery tickets are being increasingly sold by government and charitable entities around the world as sources of revenue.

Instant scratch-off lottery tickets typically contain hidden pre-printed winning or non-winning game data revealed by the player instantly upon scratching off a secure covering layer. The instant win or lose nature of these tickets distinguishes this form of lottery from the various other forms in which winning numbers are drawn some time after the sale of the ticket. The growth of popularity of these “instant” scratch-off lottery tickets with the public is explained by the public's ability to immediately learn if the ticket is a winner. The increasing popularity with the organisers of the lotteries, such as governmental and charitable entities, is explained by the advantage of knowing in advance the precise number of winners and the total value of the winnings when an entire lot or set of tickets will have been sold. Of course, the popularity of these lotteries with the public translates as well to their popularity with the governmental and charitable organisations which are constantly endeavouring to improve their lottery tickets and increase their revenues in this manner.

Algorithmic computer controlled software solutions evolved in the 1970's so commercial volumes of instant scratch-off lottery tickets could be produced for government lottery operators. The game data and game control programs created are specific and, until development of this invention, are for instant scratch-off lottery tickets that have single or spot color variable images on the play area of a substrate. Black is the most common color for game data images however, occasionally, other colors like red, green and blue, spot colors (sometimes referred to as dual colors, meaning two types of spot color) are used for visual highlights in the play area.

Throughout the 1970's and 1980's totally opaque, non-environmentally friendly foil-laminated card stocks were primarily used as the type of substrate for instant scratch-off lottery tickets. The opaque foil card stocks, together with the varnish layers and the removable scratch off ink layers, gave lottery ticket manufacturers the suitable materials needed to adequately hide game data under removable coverings and produce large volumes of these types of lottery tickets. The game design and game control programs were designed for use in single or spot color variable imaging equipment that have the capability of printing relatively simple game data, indicia and symbols consisting of numbers, letters, line drawings or figures.

Ink jet imagers were most commonly used because they print variable single and spot color game data on to foil card substrates at high printing speeds above 300 feet per minute. Occasionally, slower speed single and spot color laser printers were used. In or about 1990, an environmentally friendly, recyclable, totally opaque substrate, known as Hansell lottery paper was developed and sold for instant scratch-off lottery tickets production as an effective alternative to foil-laminated card stocks. Hansell lottery paper provided an alternative so lottery tickets, which featured single and spot color variable images, could be manufactured without the use of non-environmental foil laminated card stocks. See U.S. Pat. No. 5,213,664, for example.

By the mid 1990's lottery ticket printing technologies had developed so that commercial volumes of instant scratch-off lottery tickets could be manufactured on recyclable plain white core paper coated on one or two sides. These developments in chemistry, know how, sealing layers, varnish layers and scratch off layers are known to those skilled at the art and are referred to herein as flexo based lily pads. Products manufactured by these techniques and materials are referred to herein as plain paper lottery tickets.

The achievements meant that manufacturers of instant scratch-off lottery tickets were no longer required to use foil-laminated card stocks or Hansell lottery ticket paper, together with the varnish layers and scratch off layers, to securely hide single and spot color game data in the play areas.

Flexo based lily pads became a viable method whereby play areas could be secured purely through graphic means on recyclable plain white core coated paper. The important role of providing see through protection or opacity for game data and curtailing any migration of single and spot color game data through the substrate for which foil-laminated card stocks and Hansell lottery paper had been used in prior lottery ticket manufacturing techniques was no longer relied upon in the new large “flexo based lily pad” production system that produced plain paper lottery tickets.

Plain white core coated paper substrates provide very little opacity protection for physical security; therefore the play areas on these substrates needed a substantial amount of graphic treatment in the play areas is required so that an adequate amount of physical security could be built to protect the single and spot color game data. Plain white core coated paper functioned as the carrier for all of the flexo based lily pad graphic chemistry solutions developed to make play areas secure. The flexo based lily pad system of printing lottery tickets requires substantial investments in printing equipment and uses large quantities of pressroom chemicals to graphically build security in the secure play areas.

Nevertheless, like all earlier instant scratch-off lottery tickets, the secure play areas of plain paper lottery tickets also only feature relatively simple game data, indicia and symbols such as numbers, letters, line drawings or figures that are printed in single color black or spot colors.

In the late 1990's, to attract consumers and increase product security, manufacturers of instant scratch-off lottery tickets developed techniques which enabled stationary four colour process images to be printed on top of the scratch-off layers. This conventional printing method implies images are stationary as they not change from one printing impression to the next during a printing run. See U.S. Pat. Nos. 5,569,512 and no. 5,704,647. This should be contrasted with developments in modern digital printing systems in which images can change with each printed impression in a printing run, making it possible to print variable game and validation information in full colour variable images in the security area of instant scratch-off tickets.

Prior to this invention, methods of commercially manufacturing secure play and validation areas in volume lottery ticket production have not been combined to adequately protect, hide and physically secure near offset quality, digitally printed full colour variable images, sometimes referred to as four color process images under removable layers or scratch off coverings.

There is a desire among the organisers of these lotteries to increase their popularity thereby increasing the revenue that can be generated to the governmental and charitable entities. These entities often do so by making the lottery tickets as attractive to the public as possible. For example, techniques that have been employed include:
1. Selling Licensed Games, in which game themes and game play are tied to popular properties of entertainment and pop culture. These include the use of well known television game shows, various forms of poker, board games, iconic characters, sports teams and the like;
2. Graphics of popular themes are attractively printed on the base graphics (i.e. the non-security area) of the ticket and similar thematic printing is done over the scratch-off surface, which includes the use of stationary full colour or four colour process images such as photographs and photo quality images;
3. The use of advertising campaigns to build excitement for the tickets based on popular themes, much like the excitement that is created over big draw game lottery jackpots;
4. Exploiting the promotional appeal of popular brands and using it to create niche lottery ticket consumers and return former lottery ticket purchasers to a new lottery;
5. Monitoring consumer behaviour and reactions towards all visual and physical components of lottery tickets, which includes the relationships which consumers have towards the game play function of a lottery ticket; and
6. Continually creating and offering new styles of games which consumers see as fresh products that are just recently released for sale. By having the opportunity to purchase new game lottery tickets consumers can think they may contain better odds of winning.

These features increase the probability that a member of the public will view the ticket at a vendor site, be attracted to the ticket, and purchase the ticket for game play. Increased success for organizers of these lotteries can mean greater funding for charitable purposes such as schools, hospitals or sports associations and the like.

Throughout, the fundamental concern of organisers of these types of instant scratch-off lottery tickets is ensuring the physical security of the game play and validation information contained in the security area of these tickets, that is the area beneath the scratch off layer of the ticket. Premature disclosure of that information without removal of the scratch-off layer or premature destruction or other evidence of tampering can be used to determine whether the ticket is a winning or non-winning ticket, without having to purchase the ticket. Winning tickets can be harvested unscrupulously and non-winning tickets left for purchase by the unsuspecting public. The possibility of such premature disclosure must be prevented in order to maintain the overall integrity of the lottery and acceptability of the lottery tickets to the public.

Prevention of non-damaging premature disclosure of winning and losing tickets is of great importance in instant scratch-off lottery tickets because the tickets are generally sold through retail dealers who may have access to groups of tickets over periods of several days prior to sale. In such time periods it could be possible, if not prevented by technological means, that a dealer could select non-winning tickets for sale to the public and winning tickets for his own disposition. Destructive means of premature game data disclosure do not generally threaten the integrity of instant scratch-off lottery tickets because these techniques reveal tampering and render the tickets generally unsaleable. For example if a substrate is delaminated to obtain the game data, evidence of de-lamination will generally remain apparent to a purchaser of that ticket thereby preventing its sale. Ultimately players have to believe in the integrity of lottery ticket games that are being sold by the organizer and that players have a fair and honest chance of winning when buying a ticket.

It is important to note that testing procedures and criteria used to evaluate and approve the physical security levels of tickets vary from jurisdiction to jurisdiction. Those skilled at the art know what is involved and generally can and will agree upon what makes and does not make lottery tickets physically secure. Ticket testing sites include ticket manufacturers, lottery organizers and forensic document laboratories that have specialized examination experience in these products. In case of disputes about the physical security, ticket evaluations from various laboratories will be made and studies until a consensus between parties is reached. Failing that, a judgement through legal channels may be sought. Consequently, when the phrase, or phrases like, “secure”, “security area”, “sufficiently impenetrable to prevent determination of the contents of the image through the substrate” and “protected” are used it should be understood that this level of security meets the security level as generally determined as sufficient by these organisations. The lottery tickets and secure areas thereof, produced by this invention and method are considered to be secure in accordance with the foregoing.

In the past, in order to ensure that this confidence and trust in the lottery can be maintained, lottery tickets purchased by government lottery organizations could only be prepared with printing in the security area of single or spot colour variable images as only those types of images could be securely hidden through known techniques in the security area until the scratch-off layer is removed. The range of substrates used can include; plain white core paper coated on one or two sides, foil laminated card stocks, or Hansell lottery ticket paper as more particularly described in U.S. Pat. Nos. 5,313,664 and 5,407,535, the contents of which are hereby incorporated by reference herein.

Security of the game play and/or validation information is a significant problem which must be overcome if full colour variable images are to be used in the security area of an instant scratch-off lottery ticket. In addition this information must not be subject to tampering after the scratch-off layer is removed to prevent a player from modifying game data information into winning information.

The use of a single or spot colour information has also been protected from tampering before the scratch-off layer is removed through the use of specialty paper having a dark core coated with a light coloured layer suitable for printing, such as Hansell paper described above. Hansell paper is a substrate which is between 120 g/m² at a thickness of 130 microns and 440 g/m² at a thickness of 500 microns. It has a core of fibre based pulp furnish that contains crystalline particles from an organic carbon black pigments or black dye colorants. A fixing agent is used for the adhesion of pigments and a surface sizing treatment is applied to ensure the adhesion of a coating layer which is applied on one or two sides in a second step process.

The coating layer has an open and micro porous structure comprised of a white calcine clay and titanium dioxide pigments, which is calendered. It has a typical weight range application between 25 to 35 g/m2, per side. The coating layer has high surface strength >0.70 m/s in IGT pick testing and is free from optical brightening agents. The heavy coating layer adds opacity to the total substrate and sufficiently prevents the dark underlying colour nuance from showing through and adversely affecting the reproductive quality and appearance of the printing images.

When joined the substrate is totally opaque and the dark core cannot be separated from the coated layer without leaving evidence of tampering. The game data cannot be read through the substrate.

An alternative to the use of Hansell paper as a substrate is totally opaque aluminium foil (silver, grey or coloured) laminated to an uncoated or coated one or two side paperboard. Before liquid electrophotographic printing, the coloured surface of the foil substrate may be pre-treated with a digital primer such as DigiPrime® which aids in ink adhesion and improves rub resistance. After that, a pre-printed white lily pad layer or layers should be applied to allow for rapid and high adhesion of the full four colour image to the security area. The white lily pad would create the desired surface upon which the full colour variable images are reproduced. If conventional techniques are to be used for printing the non secure areas, the foil laminated card stock may require a pre-print coating to ensure it accepts the conventional flexo or offset inks for example. The pre-print coating may be applied at the printing house or at the converter where the foil is laminated to the paperboard.

The opaque foil laminated card stock should provide sufficient security against tampering and invasion techniques of the secure area of the lottery ticket in a similar way to the Hansell paper. However, a disadvantage of using foil card stock instead of Hansell paper is that from an environmental perspective foil is a heavy metal and is not biodegradable or recyclable into new paper products.

In the conventional structure, the variably printed game data is covered by one or more coatings designed to protect the game data from premature disclosure. These coatings include a first transparent varnish overlay to protect the game data against a coin or other object used to scratch off a covering opaque composite scratch-off coating which is usually applied by a flexo or silk screen printing technique. A second varnish layer acts as a release layer to facilitate release of the scratch-off covering from the card. The scratch-off covering is made impenetrable by conventional means in order to prevent the determination of the game data through that covering. However in the past that game data was printed in a single or spot colour, not in full colour variable images such as those produced using digital printing systems.

As an alternative to using Hansell paper with the full colour variable images hidden under protective varnish layers and scratch-off layer as described is to use a scratch-off hot foil stamp application system and materials containing an adequate amount of opacity and qualities that would provide an acceptable level of rub off performance. Two suitable hot foil stamp scratch-off material are from Kurz, product no. LOA100109 and LPMALG15SO. First a varnish layer could be applied to the substrate by hot stamping or other method like flexo or silk screen and then the scratch-off hot foil stamp would be applied. The varnish layer could help protect the full colour variable images and ensure that the scratch-off hot foil stamp releases cleanly when removed by a player. The scratch-off hot foil stamp products mentioned above can also be applied directly to Hansell paper without a varnish layer.

Lottery ticket organizers demand volumes of variable information when designing the play styles and prize payout functions of their games and these requirements are impractical to meet using conventional plate printing techniques such as offset to produce game play and validation information in the security areas of tickets. Far too many plate changes would be required to produce the vast amount of variable information in the security areas to complete a run that consisted of large volumes of tickets thus rendering plate printing for this purposes not viable.

With the advent of digital printing systems which can print volumes of full colour variable images, it becomes possible to use these systems to print variable lottery game play and/or validation information in full colour on the security areas of an instant scratch-off lottery ticket. These systems include: the liquid electrophotographic printing method; the toner electrophotographic printing method; the ultraviolet based continuous ink jet printing method; and the ultraviolet based drop on demand ink jet printing method.

The overall challenge in printing full colour variable images in the security area of an instant scratch-off lottery ticket is how to consistently manufacture volumes of tickets that contain a plurality of full colour variable images in play areas to ensure that they will be protected against invasion techniques such as light transmitting, physical, electrical, freezing, heating, X-ray, chemical, magnetic; artistic invasion and tampering.

Of utmost importance is the awareness of the requirements of lottery organizers and making sure that the method and products meet or exceed them. Starting with a clear understanding that printing of lottery tickets is considered to be a non-failure production and that any misprinted tickets should be tracked down during manufacturing and taken out before they are delivered to the lottery organizers and their retailers. If the lottery ticket manufacturer makes errors or omissions, they may be held liable, to a limited degree, for payment of prizes due to over redemption of lottery tickets.

The inventions described herein, carefully bear in mind all of the product requirements which government and charity lottery organizers require for their success and that the lottery organizers continually are working with their suppliers and urging them to develop and commercialize new exciting lottery ticket products for them.

In liquid and toner based electrophotographic printing techniques, the printed full colour variable images leave behind residual latent properties on the substrates to which they are applied. Images composed by liquid toner inks and dry toner particles contain magnetic, chemical and other latent properties which are vulnerable to detection by document security examination techniques performed on lottery tickets. The images have relief, also referred to as raised print, meaning that the images commonly sit up on top of the surface of the substrate. The height of relief of an image can be anywhere from 2 to 12 microns, depending upon the type of electrophotographic printing system, the adsorption capacity of the substrate and the density of the ink particles in the latent image. The use of electrostatic testing devices through the removable layer and through the substrate is a threat to predetermining the full colour variable image printed in the security area by liquid and toner electrophotographic techniques.

Drop on Demand ink jet systems that use UV cured inks, such as the Agfa Dotrix Transcolor and Miyakoshi MJP600 are suitable for printing full colour variable images directly on to the surface of substrates that are suitable for lottery tickets like those mentioned above. However, the printed images from these systems contain latent relief characteristics and as full colour variable images in a security area of a lottery ticket, they are vulnerable to detection by known security testing techniques. The more ink which is applied to print an image, the higher the latent relief structure of ink will be on top of the substrate. In turn, the higher the images sit above the plane of the substrate, the more difficult it becomes to securely hide and protect them in the security area of a lottery ticket. Compared to single and spot colour ink jet printed images, full colour variable ink jet UV images are at a higher risk for invasion and detection through the substrate, by the use of ink migration and fibre swelling techniques. The risk of detection is greater because the full colour variable images are non-uniform and contain properties that can be observed by wavelengths, light angles, hue, reflectance and other attributes.

In addition this information must not be subject to tampering after the scratch-off layer is removed to prevent a player from modifying game data information into winning information.

The term “instant scratch-off lottery ticket” is used for convenience only. It is to be understood that this invention includes all types of printed material for which secure, full colour, full colour variable images are desired to be hidden under scratch off coverings. For example, it is expected that the features of the invention will be used to make products such as cards, prepaid cards, vouchers, bank security instruments, coupons and the like, in full colour. As well features of the invention generally described with reference to game play information will also apply to validation information.

### Advantages

The present invention has advantages over prior art in areas of (i) ticket design and marketing (ii) the production process (iii) the environment and (iv) security. This includes the following:

### (i) Advantages In Ticket Design And Marketing

(a) Full color variable images in the play areas are true graphic representations (depictions) compared to the data, symbols, figures and indicia of prior art. True graphic representations are more vibrant, colourful, impressive, attractive, interesting, memorable, distinctive and complex compared to single color, spot color or dual spot color data, symbols, figures and indicia. For example, if the prize to be won in the scratch-off ticket is a certain brand of car, a full color image of the car to be won is superior to a single color figure of a generic car.
(b) Full color images enhance the aesthetic appearance of the ticket after it has been scratched.
(c) This method of producing lottery tickets makes it possible to customize play areas in full colour ticket designs to a particular geographical area, retailer, team, event, holiday, etc.

### (ii) Advantages In the Production Process

(a) This method of producing lottery tickets is less complex, has fewer printing stations & steps and requires substantially less financial investment than the flexo based lily pad printing process used to manufacture the prior art lottery tickets on plain paper.
(b) In this method of producing lottery tickets, all of the base graphics and all of the game graphics can be produced in one pass eliminating the costs and the time needed to print the base graphics and the game data on separate printing unit.
(c) This method of producing lottery tickets can eliminate the printing techniques, stations and pressroom chemicals required to protect the single and spot color variable images in the secure areas of plain paper based tickets.
(d) This method of producing lottery tickets makes it economically possible to do short printing runs and provide faster delivery times allowing lotteries to replace games in the marketplace with greater frequency, thus addressing an important complaint from consumers that tickets from a particular printing run continue to be sold in the marketplace even after all the high tier prizes have been claimed.
(e) This method of producing lottery tickets is not limited to 4 colors but up to 7 colors can be applied in one pass.
(f) New color matching systems such as Pantone Goe can be utilized to increase the aesthetic appearance of the full color variable images and security.
(g) This method of producing lottery tickets makes possible the development of techniques to monitor and test image accuracy, security and quality.

### (iii) Environmental Advantages

Environmental sustainability for a printer covers three elements:
(i) The Product—material used to produce it (substrates, inks, varnishes, coatings, etc).
(ii) The Process—pre-press, press, post-press, supporting technology & waste.
(iii) The Envelope—buildings, grounds, energy consumption, employees & other supporting activities required to product the product.
The general environmental advantages using this method of producing lottery tickets compared to the flexo based lily pad printing process is that it is a smaller scale operation requiring smaller facilities, less equipment, fewer personnel, less consumption of inks and other pressroom chemicals containing for example volatile organic compounds, and less waste in the production process.

### Security Advantages

(a) To make tickets more individual and to enhance security, liquid electrophotographic printing can apply variable images of micro text to the specification required by some lottery organizations for certain tickets, for example those that have a possibility of being a high tier winner. The micro text can be applied in the play area and/or in the base graphics. This is an advantage over the way micro text images are applied by conventional printing techniques such as offset which print the same stationary image of micro text and where placement of micro text images has been generally limited to the visible base graphic areas.
(b) The use of liquid electrophotographic printing in play areas enables techniques and images that are associated with Color Tiles to be employed. Color Tiles are graphical devices which are associated to function with Hewlett Packard's Indigo press technology. For example, a variety of covert, overt and anti-copy/forensic digital solutions can be created and placed in the play areas to enhance lottery ticket security. Prior art single and spot color systems used in lottery ticket production is not capable of imaging composite Color Tile clusters. The use of machine readable and human readable features in printed Color Tiles can lead to new ways to validate and authenticate tickets.
(c) For additional lottery ticket security features, the liquid electrophotographic printing capability in play areas will lend themselves to the use of color image clustering as developments in hybrid algorithms are appropriately developed and achieved.
(d) Play areas that contain a high degree of color and graphical information can effectively employ the use of steganographic artistry to embed messages in the digital printing images. Components of the embedded images can be known and recognized only through authorized validation techniques. The use of steganographic artistry in variable imaged play areas to increase lottery ticket security is not possible with state of the single and spot color imaging systems.
(e) This method of producing lottery tickets can use visible and invisible stationary benday lines separately or in combination to protect against reconstruction techniques. The combination is a superior alternative to current visible benday lines.

### SUMMARY OF THE INVENTION

The present invention provides a superior instant scratch-off lottery ticket and method of making same by printing a full colour near offset quality image in the security area of the ticket resulting in a more attractive ticket having the advantages described above. Further, the invention enables more enhanced validation features and resultant enhanced security utilising the increased variability of coloured elements in the validation image which may be dictated by factors such as relative element density; colour; and positioning, for example; as compared to single or spot coloured images.

The present invention further provides an instant scratch-off lottery ticket in which a full colour variable image in the security area of the ticket is securely hidden to prevent determination of the contents of the image in a way which would allow the ticket to be identified as a winner or non-winner unless the scratch-off layer is rightfully removed by the purchaser of the ticket.

In an embodiment of the invention an instant scratch-off card includes a substrate having a security area; a full colour graphical image printed on the security area comprising variable information variable between cards, the image printed using a digital printing method capable of printing variable images, namely the liquid electrophotographic printing method; the toner electrophotographic printing method; the ultraviolet based continuous ink jet printing method; and the ultraviolet based drop on demand ink jet printing method. The security area of the substrate has sufficient absorptive qualities to enable a rapid and high level of adhesion of the image to the security area and is sufficiently impenetrable to prevent determination of the contents of the image through the substrate. A first varnish layer covers and protects the image and a second varnish layer covers the first varnish layer. A first scratch off layer covering the second varnish layer; and a second scratch-off layer covering the first scratch-off layer. In combination, the first and second scratch-off layers are sufficiently impenetrable to prevent determination of the contents of the image through the layers and the second varnish layer facilitates release of the scratch-off layers from the second varnish layer on the removal of the scratch-off layers.

In a further embodiment the security area of the substrate can include a base layer made up of dark core material and a coating layer overlaying and secured to the base layer comprised of a bright absorptive overlay forming a coated surface suitable for printing. The base layer and coating layer cannot be separated without evidence of the separation being apparent. the base layer may be between 70 g/m² at a thickness of 90 microns and 350 g/m² at a thickness of 420 microns.

The dark core material may be fibre based pulp furnish containing a fixing agent for adhesion of pigments and a surface sizing treatment for adhesion of the coating layer. The fibre based pulp furnish may further contain crystalline particles from an organic carbon black pigment or black dye colorants.

The coating layer may have an open and micro-porous structure with a weight of 25 g/m² to 35 g/m². The coating layer may further include a white calcine clay and titanium dioxide pigments. Further the coating layer may be calendered, with a surface strength greater than 0.70 m/s based on IGT pick testing and be free from optical brightening agents.

In a further embodiment, a second coating layer covers the base layer on the opposite side as the first coating layer and the first and second coating layers and base layer are, in combination, between 120 g/m² at a thickness of 130 microns and 440 g/m² at a thickness of 500 microns.

As a further embodiment each card of a set of cards contains one of the variable images, at least a portion of which image identifies the variable information. Optionally, at least a portion of the image contains information not part of the variable information. As a further option, a portion of the image, not including the variable information, does not change from one card to another. Alternatively, the variable information is printed as a micro-text image, for enhanced security. As a further alternative, the variable information is printed by a steganographic process to embed messages as the variable information, for enhanced security.

In a further embodiment a non-security area having a non-secure full colour variable graphical image printed thereon and wherein the security area image and non-security area image are continuous to form a single complete image when the scratch-off layers are removed. The variable information may be embedded within the photographic image. The upper surface of the second scratch-off layer may contain a full colour graphical image printed thereon. The variable information may include one or more of game play information and validation information and the image on the upper surface of the second scratch-off layer substantially matches the image on the security area and is positioned in substantial register with that image; with the exception of the one or more of: game play information and validation information, which is not include in the image on the upper surface. As an alternative, the upper surface of the second scratch-off layer contains a full colour graphical image printed thereon and the image on the upper surface of the scratch-off layer substantially matches the image on the security area, is positioned in substantial register with that security area image and forms a single complete image with the non-security area image; with the exception of the game play information which is not include in the image on the upper surface.

In an alternate embodiment the variable information is validation information which includes a plurality of elements forming an image unique to that card, the plurality of elements comprise one or more differences among elements based on one or more relative elements selected from the group: density; colour; and positioning.

Alternatively, the first varnish layer comprises non-absorptive qualities which keep the first varnish layer from penetrating unevenly into the security area in order to ensure an even coverage overlay on both the printed and non-printed areas of the security area.

In a further embodiment, the substrate comprises opaque aluminium foil laminated to paperboard and wherein the security area comprises a light coloured lily pad layer to provide adhesion of the full four colour image to the security area. The surface of the foil at the security area may be pre-treated with a digital primer before applying the lily pad layer.

In an alternative embodiment an instant scratch-off card includes a substrate having a security area; a full colour graphical image printed on the security area comprising variable information, the image printed using a digital printing method capable of printing variable images, selected from the group: the liquid electrophotographic printing method; the toner electrophotographic printing method; the ultraviolet based continuous ink jet printing method; and the ultraviolet based drop on demand ink jet printing method. The security area includes sufficient absorptive qualities to enable a rapid and high level of adhesion of the image to the security area and being sufficiently impenetrable to prevent determination of the contents of the image through the substrate. A scratch-off layer includes a hot foil stamped layer, covering and protecting the image and being readily releasable from the substrate. The scratch-off layer is sufficiently impenetrable to prevent determination of the contents of the image through the layer. Optionally a varnish layer covering and protecting the image and wherein the hot foil stamped layer covers the varnish layer.

In yet a further embodiment an instant scratch-off card includes a substrate having a security area; the security area of the substrate comprising opaque aluminum foil laminated to paperboard which paperboard is either uncoated or coated on one or two sides; a light coloured lily pad layer printed onto the security area, a full colour graphical image printed on the lily pad of the security area comprising variable information, the image printed using a digital printing method capable of printing variable images, selected from the group: the liquid electrophotographic printing method; the toner electrophotographic printing method; the ultraviolet based continuous ink jet printing method; and the ultraviolet based drop on demand ink jet printing method. The lily pad layer and paperboard provides sufficient absorptive qualities to enable a rapid and high level of adhesion of the image to the security area and being sufficiently impenetrable to prevent determination of the contents of the image through the substrate. A first scratch off layer covers the security area; and a second scratch-off layer covers the first scratch-off layer; In combination, the first and second scratch-off layers are sufficiently impenetrable to prevent determination of the contents of the image through the layers.

In another embodiment a method of making an instant game card having a security area for containing variable information, includes the steps of:
(a) printing a full colour variable graphical image using a digital printing method capable of printing variable images, selected from the group:
   (i) the liquid electrophotographic printing method;
   (ii) the toner electrophotographic printing method;
   (iii) the ultraviolet based continuous ink jet printing method; and
   (iv) the ultraviolet based drop on demand ink jet printing method;
   onto a portion of the security area of the card, the card substrate including sufficient absorptive qualities to enable a rapid and high level of adhesion of the image and being sufficiently impenetrable to prevent determination of the contents of the image through the substrate;
(b) covering the security area with a first varnish layer, the first varnish layer comprising non-absorptive qualities which keep the first varnish layer from penetrating unevenly into the security area during the covering process in order to ensure an even coverage overlay on both the printed and non-printed areas of the security area;
(c) drying the first varnish;
(d) covering the first varnish layer with a second varnish layer;
(e) drying the second varnish layer; and
(f) covering the second varnish layer with an scratch-off layer which is sufficiently impenetrable to prevent determination of the contents of the image through the scratch-off layer.

### DESCRIPTION OF THE DRAWINGS

FIG. 1 illustrates a prior art card, comprising an instant scratch-off lottery ticket, with the scratch-off layer three security areas sufficiently removed to read the numerical game data and view a simple drawing all of which are printed in a single colour on top of opaque grey coloured background which can be a printed lily pad.

FIG. 2A illustrates a card, according to a preferred embodiment of the present invention, comprising an instant scratch-off lottery ticket, with scratch-off protective layers.

FIG. 2B illustrates the card of FIG. 2A, with the scratch-off layers of two security areas completely removed to reveal full colour near offset quality graphical images printed directly on to a white substrate in the security area.

FIG. 3 is a close-up view of the prior art card of FIG. 1 showing one of the three security areas with the scratch off layer completely removed. A single colour black ink jet drawing is shown printed on top of an opaque grey coloured background which can be a printed lily pad.

FIG. 4 is a close-up view of a full colour variable image in the security area of the card of FIG. 2 printed directly onto a white substrate, with the scratch-off layer completely removed.

FIG. 5 illustrates a card, comprising an instant scratch-off lottery ticket, with the scratch-off layer in place, of an alternate embodiment of the present invention.

FIG. 6 illustrates the card of FIG. 5 with the scratch-off layer completely removed to reveal a series of full colour variable images in the security area representing game play information.

FIG. 7 is a prospective cut-away view of an instant scratch-off lottery ticket of an alternate embodiment of the present invention showing the various layers in the security area.

FIG. 8 is a schematic, cross-sectional view of the security area of the card of FIG. 7.

FIG. 9A is a schematic view of the Indigo press portion of a preferred method of manufacturing an instant scratch-off lottery ticket of the present invention.

FIG. 9B is a schematic view of the silk screen line portion of a preferred method of manufacturing an instant scratch-off lottery ticket of the present invention.

### DETAILED DESCRIPTION

### Prior Art

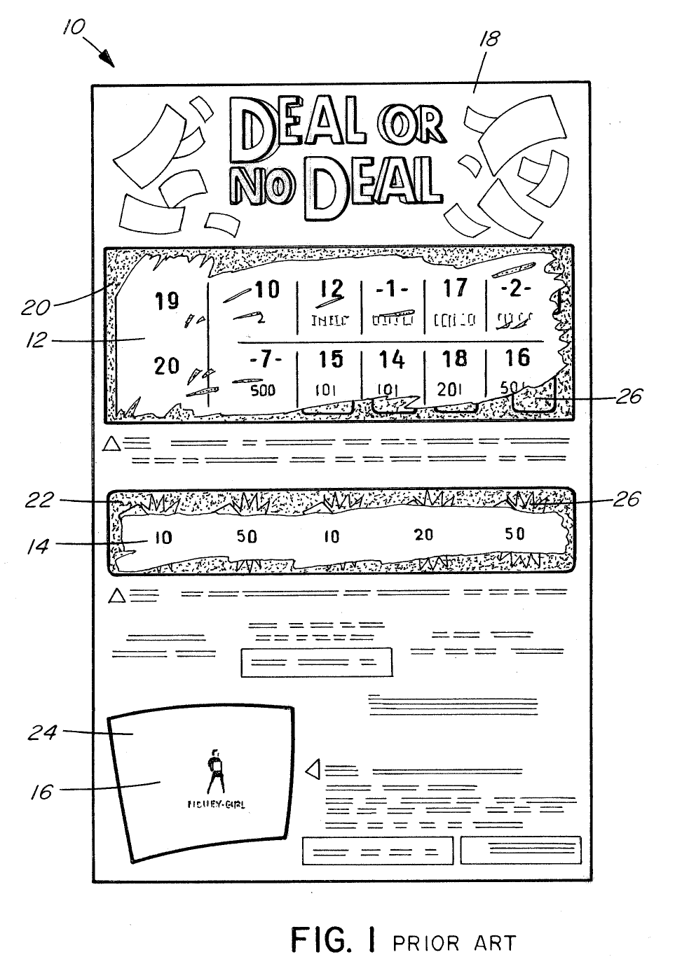

FIGS. 1 and 3 illustrate instant scratch-off lottery tickets common to the prior art. Prior art lottery ticket 10 includes security areas 12, 14 and 16 as well as non-security area 18. When purchased all of the security areas 12, 14 and 16 are covered by scratch-off layers 20, 22 and 24, respectively. In the depiction of FIG. 1, scratch-off layers 20 and 22 are only partially shown as most of those scratch-off layers have been removed. Area 16 is shown with scratch-off layer completely removed.

Scratch-off layers 20, 22 and 24 may contain a single colour image or a spot colour image.

Prior art security areas 12 and 14 show numerical game data printed in single colour black ink applied by ink jet printing and security area 16 shows a one colour black ink jet figure. All are printed on top of an opaque grey coloured lily pad, such as lily pad 24 of security area 16.

The non-secure area 18 can be printed using conventional techniques either in a single colour, spot colour or full colour, including four colour process, to provide a full colour image, which could include a photographic image or like image in non-secure area 18.

Referring to FIG. 3, security area 16 shows a relatively simple one colour black ink jet drawing 26 and words 28 that are printed by an ink jet printer on top of an opaque grey coloured lily pad.

### Preferred Embodiments

### General Discussion

Before printing, a mix of graphical elements using full colour variable images were designed and strategically placed into the secure area of sample lottery tickets consisting of different colour densities, shapes, emblems, logo'd images and background designs which included the use of visible and UV light visible benday lines to challenge ticket reconstruction, invasion and tampering techniques.

The production processes used and the detailed chemistry that is formed between the raw materials when they are joined was considered leading to the selection of a substrate; a digital printing system; a silk screen finishing line, two varnishes and two scratch-off layers.

Volume lottery ticket production is central to the invention, which means that continually a vast mixture of strong and vivid variable colour images have to be printed and hidden in the security areas of tickets. To meet this requirement a decision to use the Hansell lottery paper as the preferred substrate was made as its surface allows for maximum flexibility of ticket design, provides maximum see through protection and cannot be de-laminated. The absorptive properties of the substrates white surface were well suited to embed and adhere the full colour variable printing images.

To process and accurately print the large quantities of full colour variable graphics an industrial strength digital printing system with the capability to handle robust, highly developed software was selected. The preferred choice made was a roll fed liquid electrophotographic printing method; the Hewlett Packard Indigo Digital Press model WS 4500 in which up to 7 colors can be applied in exacting register in one pass on one side of the substrate. The selection made it possible to produce security areas on sample tickets that had 7 colors in one pass of the printing press as this was deemed beneficial for the creation of design enhancements and the security evaluations which were performed on the lottery tickets.

The Kammann model 4,61,35 five station flatbed rotary silk screen press that was selected and used as a preferred silk screen line was able to consistently apply and cure two thick and even layers of varnish and two thick and even layers of opaque silver scratch off inks over the printed security area while providing excellent rub of performance and physical security protection of the full colour variable images from the topside of the tickets.

Enhanced together with the totally opaque features of the substrate, the two layers of varnish and the two layers of scratch off inks provided an acceptable level of physical security protection to the full colour variable images that were printed in the security areas by the liquid electrophotographic printing method.

This was confirmed by a forensic document examination lab identified as Institut de Police Scientifique et de Criminologie, University of Lausanne, in Lausanne Switzerland. 100 Bandy lotto tickets underwent a series of security tests under four examination principles: Light, Heat, Freezing and Electrostatic. The tickets passed all tests and a report was issued.

This was further confirmed by a laboratory evaluation of the sample tickets which was made at the National Laboratory of Forensic Science in Linköping, Sweden. The Hansell pages from Black & White Paper Company consisted of 225 g/m² and 250 microns. Two layers of varnish and two layers of scratch-off ink were used. An Indigo press printed the full colour variable image. An English translation follows:

Using the same methods, techniques and raw materials, the results would be similar to those described above had the application of the full colour variable images been done using a toner electrophotographic printing system, a continuous ink jet UV based printing system or a drop on demand UV based ink jet printing system.

To safeguard the security areas which are printed with full colour variable images against pin pricking/light scratching, graphic design security techniques will need to be implemented by ticket manufacturers and lottery organizers who plan ticket styles, play areas and the location of prize carrying images. Graphic security and design planning will be an ongoing process during all ticket production runs that must effectively trick and camouflage the efforts of skilled pinpricking artists to ensure that the full colour variable printed information is kept securely hidden until the removable cover is rubbed off by the rightful owner of the lottery ticket,

By following and adhering to the techniques, materials and process as described in this invention the overall challenge of consistently manufacturing volumes of tickets that contain a vast quantity of full colour variable images in play areas can be met. The invention makes possible the manufacture of lottery ticket products that are attractive to players and helpful to lottery organizers. Most importantly the lottery ticket security areas can be protected against various invasion techniques such as light transmitting, physical, electrical, freezing, heating, X-ray, chemical, magnetic; artistic invasion and tampering techniques.

### Discussion With Reference To the Drawings

Card 30, in the preferred embodiment is an instant scratch-off lottery ticket, as seen in

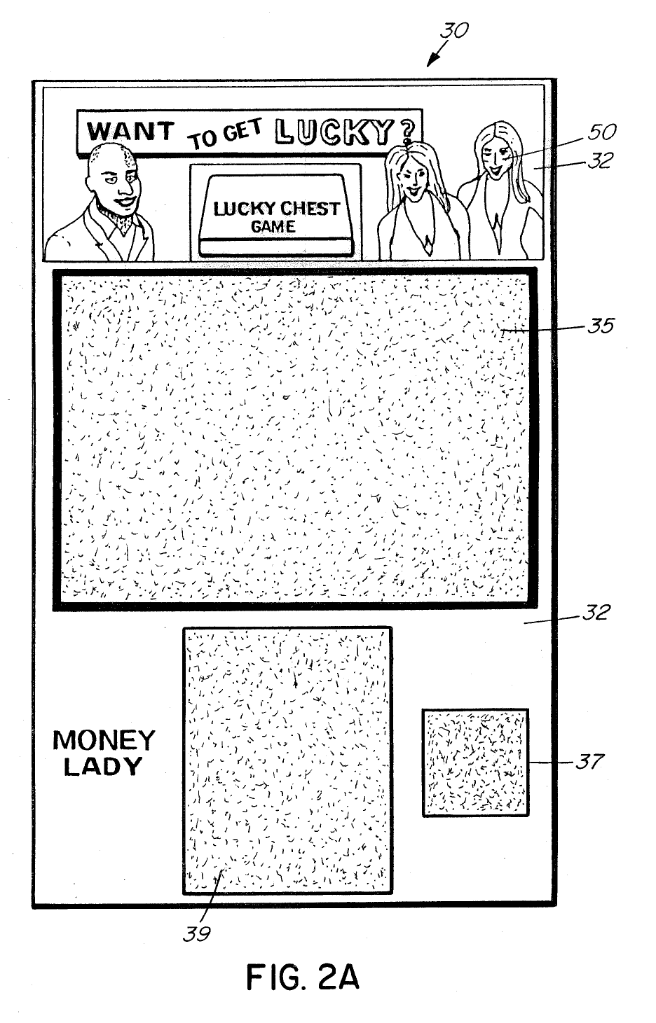

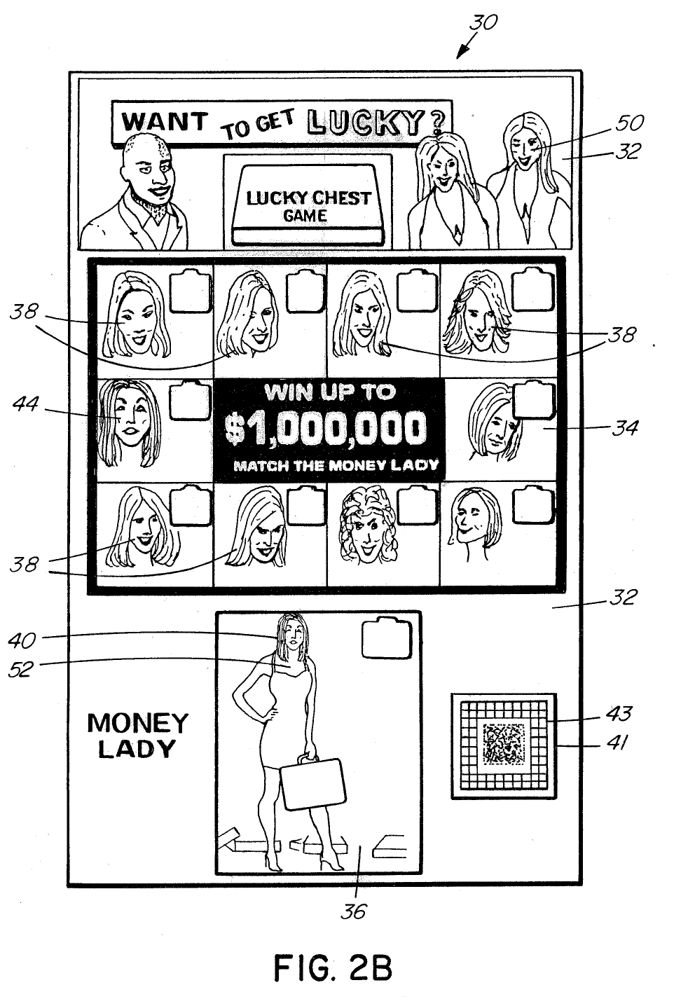

FIGS. 2A and 2B, which includes non-security area 32 together with three security areas: 34, 36 and 43.

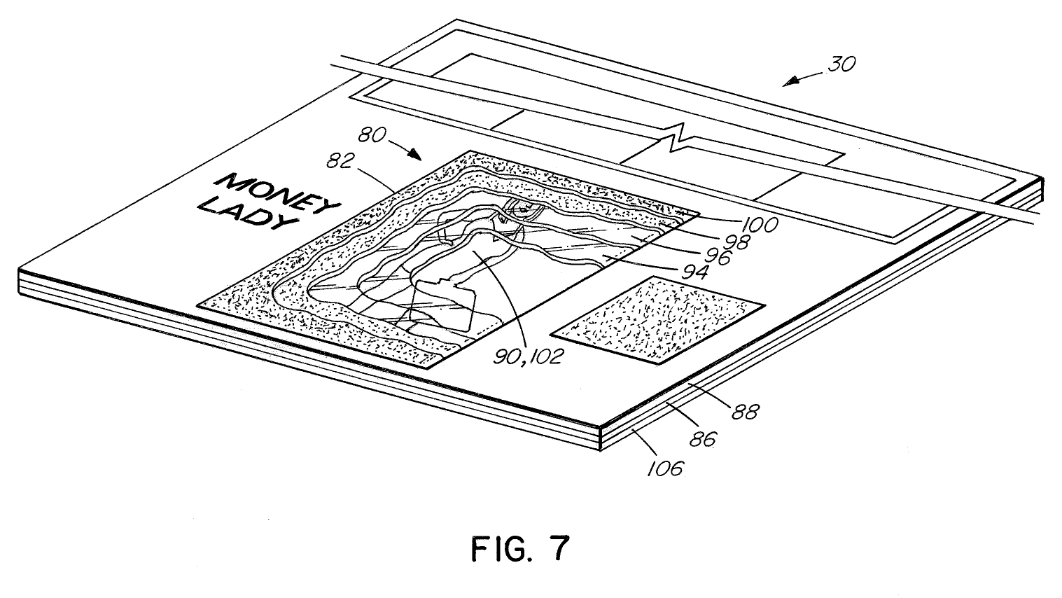

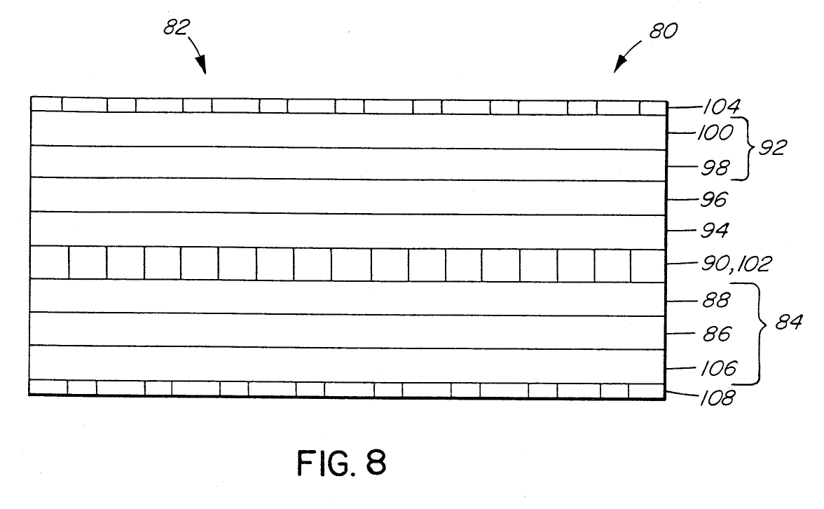

Referring initially to FIG. 2A a card is illustrated, in this case an instant scratch-off lottery ticket 30 with a non-security area 32 and three security areas 34, 36 and 43. Security areas 34, 36 and 43 (FIG. 2B), are covered with two layers of varnish and two scratch-off layers in the manner discussed below with reference to FIGS. 7 and 8. Upper scratch-off layers 35 (for security area 34), 39 (for security area 36) and 37 (for security area 43) are silver in colour covering the entire area of respective security areas 34, 36 and 43.

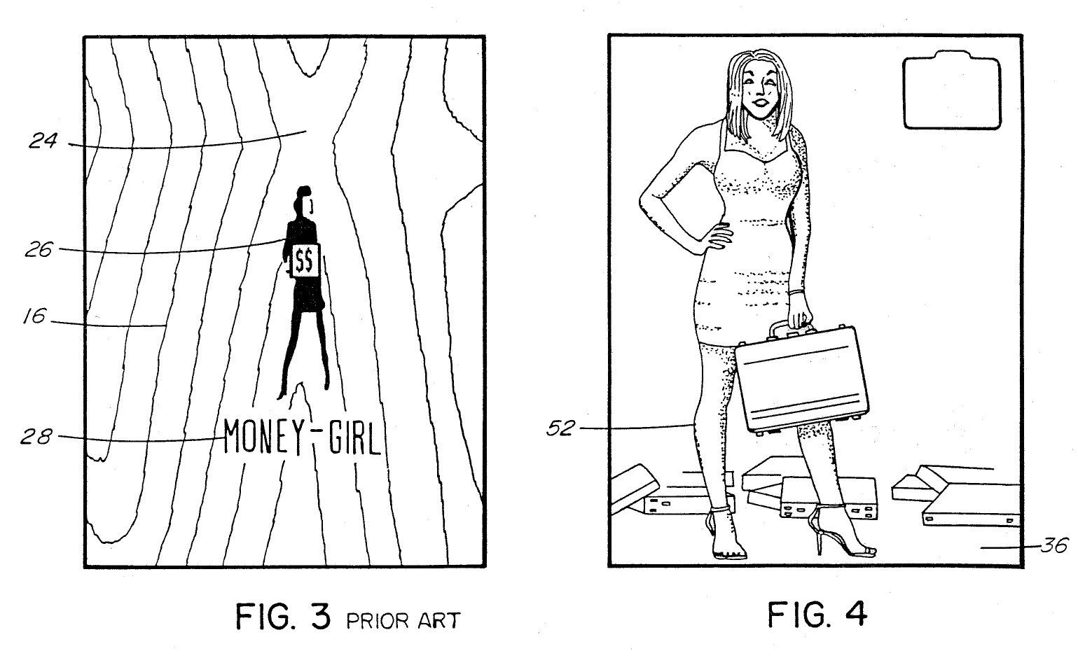

FIGS. 2B and 4 illustrate the card of FIG. 2A comprising an instant scratch-off lottery ticket 30, with the scratch-off layers of the security areas completely removed to reveal full colour variable images printed on the security area, according to a preferred embodiment of the present invention. FIG. 4 is a close-up view of security area 36, with the scratch-off layer 39 completely removed.

It should be noted that when distributed and sold, the security areas 34, 36 and 43, are completely covered by a suitable varnish and scratch-off layers (with upper scratch off layers 35, 37 and 39 shown in FIG. 2A on top). In this example, several full colour variable images 38 are hidden from view in a secure manner in security area 34 and cannot be read unless the scratch-off layer 35 is removed by a purchaser of the ticket 30. Images 38 are comprised of photographic images which also constitute game play information. Game play information indicate whether the ticket is a winning ticket or a non-winning ticket. In this example the game play information comprises a visual match between image 44 of security area 34 and image 40 of security area 36.

Photographic images 38, 40 and 44 may contain game play information as in the example of FIG. 2A, or may be intended only to provide an attractive full colour image in the security areas 34 and 36 of card 30, without game play information, in which case printed information in other areas of security areas 34 and 36 provide non-graphical information such as numbers or words that provide the game play information. Or the game play information can be a combination of graphical images (for example a visual match between images 40 and 44) as well as non-graphical information (such as numerical information indicating the amount to be awarded for that match). Photographic images 38, 40 and 44 are in full colour printed on security area by means of a full colour variable digital printing method. Several printing methods are capable of printing variable colour images, including liquid electrophotographic printing, toner electro-photographic printing, ultraviolet continuous inkjet printing, and ultraviolet drop on demand inkjet printing. In the preferred embodiment liquid electro-photographic printing is utilized, more particularly a printing method undertaken by a Hewlett-Packard Indigo Digital Printing System.

In the example of FIG. 2A a winning ticket is one where the full colour photographic image 40 of security area 36 matches one of the full colour photographic images located in security area 34. In this case, photographic image 40 in security area 36 matches with image 44 of security area 34. Note further that additional game play information can be included, such as the name associated with images 40 and 44 of the female person depicted which matches in both security area 34 and security area 36 in order to provide the player with additional verification of a winning ticket.

There are various options for printing full colour images on card 30. In the example of FIG. 2B, the graphical images 50 in the non-security area 32 do not match any of the images contained in security areas 34 and 36.

Another option is to provide a larger graphical image that presents one complete image covering both non-security area 32 and security areas 34 and 36. Users who remove the scratch-off layer then have a complete image. Even if the card is a non-winning card, purchasers may wish to keep the card based on the graphical image which could be of a famous sports figure, movie star, or other graphical image of value to the purchaser. The non-secure area can act as a “teaser” providing a potential purchaser with incentive to purchase a particular lottery ticket with the knowledge that they will, at least, receive a full colour picture consistent with the graphical image of the non-security area 32 of the card 30.

As an alternate feature, a full colour image can be printed on to the scratch-off layer. The image on the scratch-off layer can also be a part of a larger image when combined with the full colour image on the non-security area to form a complete image. This can also act to attract potential purchasers to purchase the ticket. As a further option, the graphical image printed on the scratch-off layer can match and be in register with the graphical image underneath the scratch-off layer with one important modification. As will be apparent, it is important to maintain the confidential nature of the game play information and that information would not be included on the top of the scratch-off layer in that graphical image. All of these features would be beneficial to the lottery ticket issuer and the retailer selling the ticket in making the lottery tickets more attractive to users and providing them with some “residual” value even if the lottery ticket turns out to be a non-winning ticket, in that while no financial or other compensation is payable under that ticket, the ticket will still be of value to the purchaser based on the nature of the image.

FIG. 4 depicts a portion of card 30 of FIG. 2B of security area 36 with the scratch-off layer 39 (FIG. 2A) removed. The use of a full colour image of the female 52 in security area 36 can be compared to the black image 26 of a female of the prior art lottery ticket 10, as depicted in FIG. 3.

It is often necessary to include coded validation information on instant win lottery tickets to enable the lottery administrators to verify that a particular winning ticket returned for payment is a proper verified winning ticket. This can be done by means of coded numbers, letters or other symbols or arrays of symbols. Validation information can be placed on the ticket in non-secure areas, such as non secure area 32 of card 30 of FIG. 2A, or in one or more security areas 34, 36 and 43. In the past the validation information has been printed in one colour or spot colour.

However, with the ability to print full colour variable images it is now possible to print full colour validation information, unique to each lottery ticket, in the same manner as the graphical information discussed herein. The ability to print full colour variable images as coded validation information provides further benefits to the use of variable full colour printing techniques to production and distribution of lottery tickets. Referring to FIG. 2B, security area 43 includes a relatively sophisticated color tile, constituting four colour variable image 41 containing coded information to validate card 30 as constituting a winning lottery ticket. Each card 30 has a unique graphical image and corresponding validation information 41 printed using a variable colour printing method as described herein. Special reading technology and associated readers can be used to read and authenticate the validation information comprised of these colour tiles. Colour tile readers could be restricted to the lottery administrator's possession, and used just for validating the higher prize cards 30. The purchase and operation of color tile reading devices for authentication of prize payout tickets would not be significant investments for the lottery organizers in order to upgrade and enhance security.

An overall increase in security for lottery tickets can be provided by using the very complex secret validating algorithms associated with these colour tiles constituting four colour variable image 41, for ticket identification, reading and control. Algorithmic complexities can be greatly upgraded from the reliance on simpler algorithms that have to use, whether manually or machine readable, single and spot color data, bar codes and indicia. These new more complex algorithms can rely on differences among individual coloured elements of the validation information based on one or more relative element differences including differences in density, colour, and/or positioning. For example Hewlett-Packard has developed systems used in association with its Indigo Digital Printing System to use enhanced “variable image read capabilities” with these types of colour tiles, although not in validating lottery tickets.

Lottery ticket validation and inspection systems, could be integrated to use these color tile advances by ticket manufacturers and lottery administrators in applications that range anywhere from activating “lottery ticket” books at retailer sites, tracking sales and inventories to authorizing and authenticating the payouts of tickets, including the most valuable high tier winning tickets.

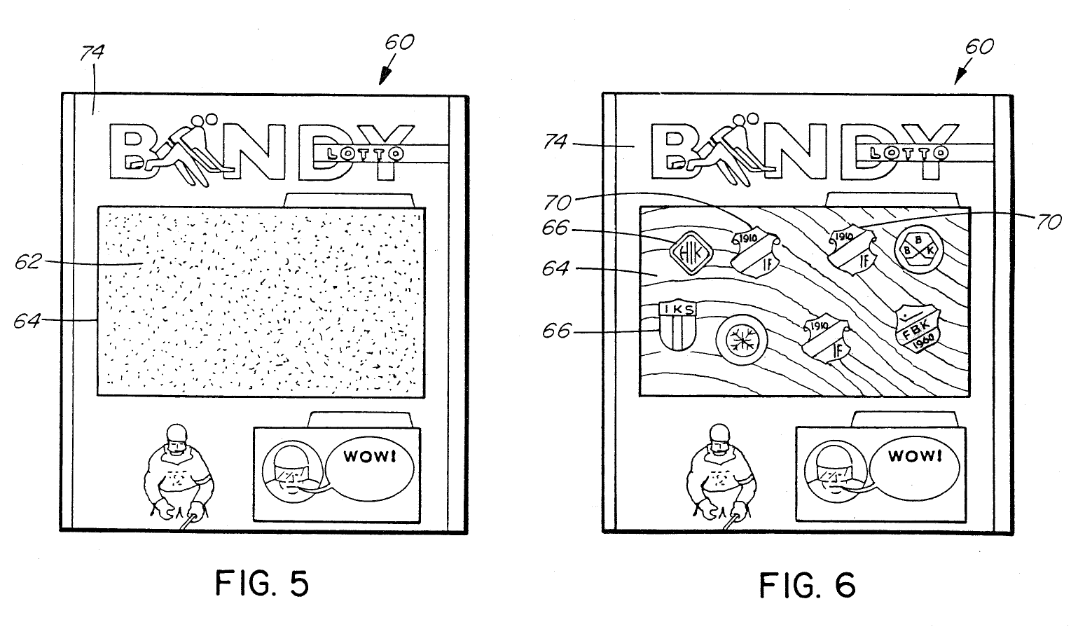

FIGS. 5 and 6 illustrate an instant scratch-off lottery ticket of an alternate embodiment of the present invention. FIG. 5 depicts ticket 60 with scratch-off layer 62 covering security area 64. Security area 64 is best seen in FIG. 6. FIG. 6 depicts the same card 60 but with scratch-off layer 62 (depicted in FIG. 5) removed to show security 64 along with 8 full colour graphical images 66 which represent various Swedish Bandy team emblems. Each graphical image 66 constituting game play information. If a winning ticket is one in which there are three matching images 66, it can be seen that ticket 60 constitutes a winning ticket as graphical images 70 all match.

In this example, the full colour and spot colour images contained in non-secure area 74 remains static with each lottery ticket of a set of lottery tickets. On the other hand, the game play information constituting graphical images 66 vary from card to card of a particular lottery set or game play series, between winning tickets (3 matched graphical images such as graphical images 70) and non-winning tickets, with no such match. Graphical images 66 inherently contain game play information in that matching the images will indicate that a particular card is a winning or non-winning card depending on whether three of those images match on a single card.

Again it can be seen that the use of full colour images in security area 64 provides a significant advantage over the prior art single colour or spot colour images as depicted in FIG. 1. Full colour images 66 may be printed using the same printing systems as discussed above with respect to FIGS. 2A and 2B. In addition, some of these printing systems can print more than four colours and can be suitable for printing a four colour near offset quality graphical image, in addition to printing separate one colour or multicolour data. In this way, the entire face of ticket 60 can be printed with one pass through the printer, with the same static images from card to card being printed on non-security area 74 and a variable images (images that change from card to card), including graphical images 66 and associated game play information printed simultaneously.

FIGS. 7 and 8 depict a bottom portion of card 30 of FIGS. 2A and 2B, herein referenced as “ticket 80”, which will be referred to in describing the various components of ticket 80. FIG. 7 is a perspective cut-away view of ticket 80 showing the various layers in the security area 82. FIG. 8 is a schematic, cross-sectional view of the security area 82 of the lottery ticket 80 of FIG. 7.

In the preferred embodiment ticket 80 includes substrate 84 which is preferably Hansell lottery ticket paper sold by Black & White Black & White Paper Mfg. AB, Box 34. S-790 20, Grycksbo, Sweden. Substrate 84 includes core 86 made up of a layer of dark core material which can be fibre based pulp furnish containing a fixing agent for adhesion of pigments and a surface sizing treatment for adhesion of a coating layer. The fibre based pulp furnish can contain crystalline particles from an organic carbon black pigments or black dye colorants. The core 86 is preferably between 70 g/m² at a thickness of 90 microns and 350 g/m² at a thickness of 420 microns.

An upper or first coating layer 88 is attached to core 86 in such a manner as to prevent the de-lamination of layer 88 from core 86 without that de-lamination being readily apparent. Layer 88 preferably has a porous and micro-crystalline structure with a weight of 25 g/m² to 35 g/m². Layer 88 can be comprised of a white pigment providing rapid and a high level of absorption of printing ink due to its composition. That composition can include significant volumes of white calcine clay and titanium dioxide pigments in suitable quantities to ensure proper adhesion and absorption of a full colour graphical image 90 to layer 88. More particularly coating 88 may include calcine clay, and engineered clay, a binder, a thickener, a de-foamer and a hardener. Coating layer 88 may further be calendered, of relatively high surface strength (greater than 0.70 m/s in IGT pick testing) and free from optical brightening agents. The coating layer prevents the dark underlying core 86 from showing through and adversely affecting the reproductive quality and appearance of the full colour variable image on layer 88.

As discussed above, graphical image 90 is a full colour graphical image, including an image produced by a four colour process digital printing system capable of producing full colour variable images such as that produced by either: the liquid electro-photographic printing method; the toner electro-photographic printing method; the ultraviolet continuous inkjet printing method; and the ultraviolet drop on demand inkjet printing method.

Image 90 is a variable image, that is it varies from ticket 80 to ticket 80 of a single lottery ticket game and contains the game play information such that some lottery tickets 80 contain winning information in security area 82 visible upon removal of the scratch-off layers 92. Other tickets contain a graphical image 90 representing non-winning information for a non-winning lottery ticket.

Substrate 84 comprises sufficient absorptive qualities to enable a rapid and high level of adhesion of the image to the security area due to the composition of layer 88 and is sufficiently impenetrable to prevent determination of the contents of the image through the substrate due to the content and thickness of core 86.

When joined the substrate is totally opaque and the dark core cannot be separated from the coated layer without leaving evidence of tampering. The game data cannot be read through the substrate.

A first non-coloured varnish layer 94 covers and protects graphical image 90 from being removed when a purchaser removes scratch-off layer with a coin, key or other sharp or abrasive article. Scratch-off layer 94 also protects graphical image 90 once scratch-off layer 92 is removed to prevent manipulation of the graphical image and to preserve it for future use by a purchaser, as more particularly discussed above. The first varnish layer 94 is non-conventional in that it has non-absorptive qualities which keep the first varnish layer 94 from penetrating too far into or unevenly into the substrate 84 during the application process. The first varnish layer 94 ensures an even coverage overlay on both the printed and non-printed areas of security area 82.

A second non-coloured varnish layer 96 is a conventional varnish layer which covers first varnish layer 94 and acts as a release layer to ensure that scratch-off layers 92 can be readily released from security area 82 after the purchaser has purchased ticket 80. The second varnish layer also acts as a release layer which provides slip to ensure that the overlaying scratch off structure can be removed by a player.

A first scratch-off layer 98 covers second varnish layer 96 as a part of scratch-off layers 92. The surface of second varnish layer 96 sufficiently adheres to the first scratch off layer 98, so that the overlaying scratch off layer structure 92 cannot be unscrupulously lifted off to reveal the full colour variable printed information underneath.

Second scratch-off layer 100 covers first scratch-off layer 98. Together, scratch-off layers 92 provide an opaque scratch-off layer which is sufficiently impenetrable to prevent determination of the contents of graphical image 90 through layers 92. In this way graphical image 90 and game play information 102 (FIG. 7) are protected from unauthorized determination until, and only unless, scratch-off layer 92 is removed from security area 82. As discussed above, in this example the image 90 includes the game play information 102 as a part of image 90.

The scratch off inks are conventional and are based on latex or other polymers that include metal particles, like aluminium or other opacity building pigments which are free of metal, like for example carbon black. Wherein, in combination with the two varnish layers 94 and 96, the two scratch off layers 92, and substrate 84 form a security envelope structure which effectively hides and protect the full colour variable images printed underneath in security area 82.

As discussed above the upper side of second scratch-off layer 100 can contain a graphical image which may be viewed by purchasers and potential purchasers. However, graphical image 104 is overprinting on scratch-off layer and does not contain any secure game play information 102.

As an optional alternative, substrate 84 can include lower coating layer 106, similar to upper coating 88 to provide a white or light coloured printing surface for graphical or other printed images 108 to be printed on lower coating layer 106. The thickness of core 86 and layers 88 and 106 are preferably, between 120 g/m² at a thickness of 130 microns and 440 g/m² at a thickness of 500 microns.

### Method of Manufacture

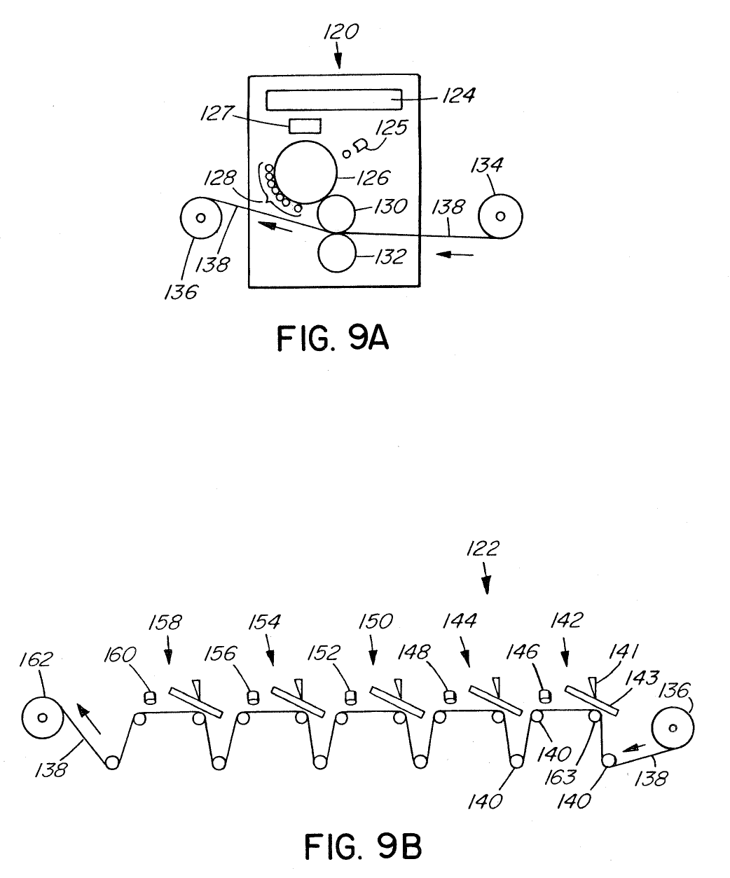

FIGS. 9A and 9B are schematic view of a preferred method of manufacturing an instant scratch-off lottery ticket of the present invention. The main components are a Hewlett Packard Indigo brand press 120 as shown in FIG. 9A and a silk screen line 122 as shown in FIG. 9B.

Referring to FIG. 9A, Indigo press 120 can print full colour variable images, that is images that are full colour and change from one printed impression to the next printed impression continuously. Press 120 is controlled by a computer (not shown) which provides data representative of each successive impression image or images to be printed. In addition to the ability to print full colour images using 4 colour ink in a process colour system, press 120 can also print additional colours to provide versatility in printing single colour or plurality of colour with only one pass through press 120.

Press 120 includes a laser imager 124 controlled by the computer to create the image to be printed. A photo imaging plate 126 obtains ink simultaneously from several ink developer units 128 to establish an image on plate 126. The image is transferred to transfer cylinder 130. As paper 138 passes between transfer cylinder 130 and compression cylinder 132 the image is printed on the paper 138. Residual ink and electrical charge removal is carried out be remover 125 and plate 126 is then ready for the next image, which is a different image that the previously printed image. Press 120 thereby prints variable images onto paper 138. After printing the paper 138 is rolled onto paper roll 136.

Referring to FIG. 9B, paper 138 from roller 136 is fed into the silk screen line 122, also known as a flat bed rotary silk screen press. Paper 138 passes through a series of guide rollers 140 to first silk screen printer 142 which applies a protective first varnish layer onto the security area of the lottery ticket to cover and protect the game play information. Squeegee 141 applies the varnish to screen 143 set against impression cylinder 163 in a manner familiar to those skilled in the art. An ultraviolet curing lamp 146 cures the varnish onto the security area of the ticket.

Paper 138 is then fed into a second silk screen printer 144 which applies a second varnish layer, a release layer, onto the first varnish layer. The second varnish layer is then cured with infra red lamp 148.

Paper 138 then passes to a third silk screen printer 150 where a first scratch-off layer is applied, which can be silver coloured ink. First scratch-off layer is cured using ultraviolet lamp 152.

Paper 138 then passes to a fourth silk screen printer 154 where a second scratch-off layer is applied over the first scratch-off layer and that layer is cured by ultraviolet lamp 156.

An optional fifth silk screen printer 158 can be used to apply an overprinting onto the second scratch-off layer, if desired, which is cured by ultraviolet lamp 160.

Alternatively fifth silk screen printer 158 can print a light coloured covering over the second scratch off layer. A second Indigo brand printer (not shown), or a traditional four colour process press can then print a process full colour image onto the light coloured covering over the second scratch-off layer. The full colour image on the second scratch off layer can dovetail and be continuous with the image on the non-security area of the card to form a single complete full colour image, variable from ticket to ticket of subsequent impressions of press 120.

In addition, as a further alternative the full colour image on the second scratch off layer can be identical to (except as to game play information) and in register with the full colour image printed in the security area underneath the scratch-off and varnish layers. That image can further dovetail and be continuous with the image on the non-security area of the card to form a single complete full colour image.

Paper 138 is then stored on roll 162.

An option to the method of manufacture for applying the varnish layers and scratch-off layers would be to use a flexography based system, rather than the flat bed rotary silk screen press and system described above. Since individual flexo printing stations cannot apply varnish layers or removable scratch off layers at the same high thicknesses and volumes as a flat bed rotary silk screen system, a greater number of flexo stations would be required. Three stations for the varnish and three to four stations for the scratch-off inks are suggested. The chemistry, structure and composition of the varnishes and removable scratch-off layers designed for use in a flexo based system would need to be chosen so that the unique latent properties and relief characteristics of the full colour variable images would be securely hidden from the topside of the ticket.

Alternatively, instead of using a flat bed rotary silk screen press, a rotary or semi rotary silk screen press that accommodates narrow web widths can be used to apply the two varnish layers and two scratch-off layers described in this invention. The advantages of rotary silk screen printing may include more accurate register and faster make ready time.

### Alternatives

A way to achieve greater adhesion, durability and print performance of liquid electrophotographic printing methods on Hansell lottery paper or foil laminated card stock would be through the use of pre-print treatments such as DigiPrime® and Topaz available from Michelman, Inc. of Cincinnati, Ohio, a manufacturer of coating and other chemicals. These digital primers are optimized for use with Hewlett Packard Indigo Digital Printing System and produce excellent ink transfer and adhesion on a wide variety of substrates while improving rub resistance. They are considered environmentally and workplace friendly. A pre-treatment application, one flexo station could apply a light coating weight of approximately 2 g/m2 over the entire surface on one side of Hansell lottery paper of foil laminated card stock.

Other digital printing systems that print full colour variable images in sequence include water based continuous ink jet and drop on demand ink jet systems. Due to the high water content of the CMYK inks formulated for use in these systems, getting the full colour variable images to adhere on to the surface of the substrates mentioned above is a challenge. The vehicle carrying the ink pigments, which in these systems contains a high amount of water, runs off the surface upon contact with the surface of the substrates, leaving a runny and visibly poor quality of image. The image quality would not be acceptable for use in the secure areas of lottery tickets. While a drop on demand water based ink jet system, like the Kodak Versamark VL2000, can print at a desirable speed for lottery ticket production at approximately 250 feet per minute, its heavily water based inks are not compatible with the substrates that are suitable for production of lottery tickets.

To achieve the same results with digital printing systems; of the water based continuous ink jet and drop on demand ink jet types, modifications to the properties of the coated surface of the Hansell paper would be required to create a sufficient level of absorption, adhesion and fastening of full colour variable images that are printed the with heavily water based inks. The modifications could be made by including silica based or aluminum based additives into the formula of the white pigment based coating slurry. These additives would help to coated surface layer to fasten the images that are printed with the runny heavily water based inks so that they would be of acceptable quality for the security areas of lottery tickets. Silica based additives dry quickly when exposed to ambient air making them trickier to work with during the coating application process and they are also expensive, therefore the use of aluminum based particles would be the recommended option. Another alternative approach to create a sufficient level of absorption, adhesion and fastening of the heavily water based inks is to implement the use of silica based or aluminum based additives into a white lily pad layer that would be applied through digital or conventional printing techniques where the four colour variable is printed in the security area. Once a sufficient level of fastening of the water based ink jet, full colour variable images is created for the security areas, the subsequent methods and materials described in this invention should be followed. The final result would be similar to what was achieved in this invention using the liquid electrophotographic printing system.

While this invention has been described as a having a preferred design or designs, it is understood that it is capable of further modifications, uses and/or adaptations of the invention following in general the principle of the invention and including such departures from the present disclosure has come within the known or customer practice in the art to which the invention pertains and as may be applied to the central features herein before set forth, and fall within the scope of the invention and of the limits of the appended claims. For example while game play and validation information have been described, other information may be printed in full variable colour images and hidden in the security area of a card.

1. An instant scratch-off card, comprising:
(a) a substrate having a security area;
(b) a full colour graphical image printed on the security area comprising variable information variable between cards, the image printed using a digital printing method capable of printing variable images, selected from the group:
(i) the liquid electrophotographic printing method;
(ii) the toner electrophotographic printing method;
(iii) the ultraviolet based continuous ink jet printing method; and
(iv) the ultraviolet based drop on demand ink jet printing method;
(c) the security area of the substrate comprising sufficient absorptive qualities to enable a rapid and high level of adhesion of the image to the security area and being sufficiently impenetrable to prevent determination of the contents of the image through the substrate;
(d) a first varnish layer covering and protecting the image;
(e) a second varnish layer covering the first varnish layer;
(f) a first scratch off layer covering the second varnish layer; and;
(g) a second scratch-off layer covering the first scratch-off layer; wherein, in combination, the first and second scratch-off layers are sufficiently impenetrable to prevent determination of the contents of the image through the layers and wherein the second varnish layer facilitates release of the scratch-off layers from the second varnish layer on the removal of the scratch-off layers.

2. The card as described in claim 1 wherein the security area of the substrate comprises:
(a) a base layer comprised of dark core material; and
(b) a coating layer overlaying and secured to the base layer comprised of a bright absorptive overlay forming a coated surface suitable for printing;
wherein the base layer and coating layer cannot be separated without evidence of the separation being apparent.

3. The card as described in claim 2 wherein the dark core material is fibre based pulp furnish containing a fixing agent for adhesion of pigments and a surface sizing treatment for adhesion of the coating layer.

4. The card as described in claim 3 wherein the fibre based pulp furnish further contains crystalline particles from an organic carbon black pigment or black dye colorants.

5. The card as described in claim 2 wherein the coating layer has an open and micro-porous structure with a weight of 25 g/m² to 35 g/m².

6. The card as described in claim 5 wherein the coating layer comprises a white calcine clay and titanium dioxide pigments.

7. The card as described in claim 2 wherein the coating layer is calendered, has a surface strength greater than 0.70 m/s based on IGT pick testing and is free from optical brightening agents.

8. The card as described in claim 2 wherein the base layer is between 70 g/m² at a thickness of 90 microns and 350 g/m² at a thickness of 420 microns.

9. The card as described in claim 2 wherein a second coating layer covers the base layer on the opposite side as the first coating layer and wherein the first and second coating layers and base layer are, in combination, between 120 g/m² at a thickness of 130 microns and 440 g/m² at a thickness of 500 microns.

10. The card as described in claim 1 wherein the liquid electrophotographic printing method is one of such printing methods undertaken by an Hewlett Packard Indigo digital press.

11. The card as described in claim 1 wherein each card of a set of cards contains one of the variable images, at least a portion of which image identifies the variable information.

12. The card as described in claim 11 wherein at least a portion of the image contains information not part of the variable information.

13. The card as described in claim 11 wherein a portion of the image, not including the variable information, does not change from one card to another.

14. The card as described in claim 11 wherein the variable information is printed as a micro-text image, for enhanced security.

15. The card as described in claim 11 wherein the variable information is printed by a steganographic process to embed messages as the variable information, for enhanced security.

16. The card as described in claim 1 further comprising a non-security area having a non-secure full colour variable graphical image printed thereon and wherein the security area image and non-security area image are continuous to form a single complete image when the scratch-off layers are removed.

17. The card as described in claim 11 wherein the image is either a photographic, vector, or bitmapped image.

18. The card as described in claim 17 wherein the variable information is embedded within the photographic image.

19. The card as described in claim 1 wherein the upper surface of the second scratch-off layer contains a full colour graphical image printed thereon.

20. The card as described in claim 19 wherein the variable information comprises one or more of: game play information and validation information and wherein the image on the upper surface of the second scratch-off layer substantially matches the image on the security area and is positioned in substantial register with that image; with the exception of the one or more of: game play information and validation information, which is not include in the image on the upper surface.

21. The card as described in claim 16 wherein the upper surface of the second scratch-off layer contains a full colour graphical image printed thereon and the image on the upper surface of the scratch-off layer substantially matches the image on the security area, is positioned in substantial register with that security area image and forms a single complete image with the non-security area image; with the exception of the game play information which is not include in the image on the upper surface.

22. The card as described in claim 11 wherein the image is an image suitable for retaining by the purchaser as memorabilia.

23. The card as described in claim 1 wherein the graphical image is a digital photograph or drawing.

24. The card as described in claim 1 wherein the graphical image is a four colour process image.

25. The card as described in claim 24 wherein the image include from one to four additional colours.

26. The card as described in claim 1 wherein the variable information comprises one or more of: game play information and validation information.

27. The card as described in claim 26 wherein the game play information is lottery game information for playing a scratch-off lottery game.

28. The card as described in claim 26 wherein the variable information is validation information which comprises a plurality of elements forming an image unique to that card, the plurality of elements comprise one or more differences among elements based on one or more relative elements selected from the group:
(a) density;
(b) colour; and
(c) positioning.

29. The card as described in claim 1 wherein the variable information is game play information and wherein the substrate further comprises a validation security area with a full colour variable image printed on the validation security area comprising variable validation information, the image printed using a printing method capable of printing variable images, selected from the group:
(i) the liquid electrophotographic printing method;
(ii) the toner electrophotographic printing method;
(iii) the ultraviolet based continuous ink jet printing method; and
(iv) the ultraviolet based drop on demand ink jet printing method.

30. The card as described in claim 1 wherein the card is a lottery ticket, a coupon, a voucher or a prepaid card.

31. The card as described in claim 1 wherein the security area of the substrate comprises:
(a) a base layer comprised of a dark core material which is fibre based pulp furnish containing a fixing agent for adhesion of pigments and a surface sizing treatment for adhesion of the coating layer, with a thickness of between 70 g/m² at a thickness of 90 microns and 350 g/m² at a thickness of 420 microns; and
(b) a coating layer overlaying the base layer comprised of an open and micro-porous structure, white calcine clay and titanium dioxide pigments with a weight of 25 g/m² to 35 g/m²′ is calendered, has a surface strength greater than 0.70 m/s based on IGT pick testing and is free from optical bleaching agents;
wherein the base layer and coating layer cannot be separated without evidence of the separation being apparent.

32. The card as described in claim 1 wherein the first varnish layer comprises non-absorptive qualities which keep the first varnish layer from penetrating unevenly into the security area in order to ensure an even coverage overlay on both the printed and non-printed areas of the security area.

33. The card as described in claim 1 wherein the substrate comprises opaque aluminium foil laminated to paperboard and wherein the security area comprises a light coloured lily pad layer to provide adhesion of the full four colour image to the security area.

34. The card as described in claim 33 wherein the surface of the foil at the security area is pre-treated with a digital primer before applying the lily pad layer.

35. An instant scratch-off card, comprising:
(a) a substrate having a security area;
(b) a full colour graphical image printed on the security area comprising variable information, the image printed using a digital printing method capable of printing variable images, selected from the group:
(i) the liquid electrophotographic printing method;
(ii) the toner electrophotographic printing method;
(iii) the ultraviolet based continuous ink jet printing method; and
(iv) the ultraviolet based drop on demand ink jet printing method;
(c) the security area comprising sufficient absorptive qualities to enable a rapid and high level of adhesion of the image to the security area and being sufficiently impenetrable to prevent determination of the contents of the image through the substrate;
(d) a scratch-off layer comprising a hot foil stamped layer, covering and protecting the image and being readily releasable from the substrate; wherein, the scratch-off layer is sufficiently impenetrable to prevent determination of the contents of the image through the layer.

36. The card as described in claim 35 further comprising a varnish layer covering and protecting the image and wherein the hot foil stamped layer covers the varnish layer.

37. An instant scratch-off card, comprising:
(a) a substrate having a security area;
(b) the security area of the substrate comprising opaque aluminum foil laminated to paperboard which paperboard is either uncoated or coated on one or two sides;
(c) a printed lily pad layer or preprint treatment coating layer applied onto the security area, (d) a full colour graphical image printed on the lily pad layer or preprint coating layer of the security area comprising variable information, the image printed using a digital printing method capable of printing variable images, selected from the group:
(i) the liquid electrophotographic printing method;
(ii) the toner electrophotographic printing method;
(iii) the ultraviolet based continuous ink jet printing method; and
(iv) the ultraviolet based drop on demand ink jet printing method;
(e) wherein the lily pad layer or preprint coating layer and paperboard provides sufficient absorptive qualities to enable a rapid and high level of adhesion of the image to the security area and being sufficiently impenetrable to prevent determination of the contents of the image through the substrate; and
(f) a first scratch off layer covering the security area; and;
(g) a second scratch-off layer covering the first scratch-off layer; wherein, in combination, the first and second scratch-off layers are sufficiently impenetrable to prevent determination of the contents of the image through the layers.

38. A method of making an instant game card having a security area for containing variable information, the method comprising the steps of:
(a) printing a full colour variable graphical image using a digital printing method capable of printing variable images, selected from the group:
(i) the liquid electrophotographic printing method;
(ii) the toner electrophotographic printing method;
(iii) the ultraviolet based continuous ink jet printing method; and
(iv) the ultraviolet based drop on demand ink jet printing method;
onto a portion of the security area of the card, the card substrate comprising sufficient absorptive qualities to enable a rapid and high level of adhesion of the image and being sufficiently impenetrable to prevent determination of the contents of the image through the substrate;
(b) covering the security area with a first varnish layer, the first varnish layer comprising non-absorptive qualities which keep the first varnish layer from penetrating unevenly into the security area during the covering process in order to ensure an even coverage overlay on both the printed and non-printed areas of the security area;
(c) drying the first varnish;
(d) covering the first varnish layer with a second varnish layer;
(e) drying the second varnish layer; and
(f) covering the second varnish layer with an scratch-off layer which is sufficiently impenetrable to prevent determination of the contents of the image through the scratch-off layer.

39. The card as described in claim 1 wherein the substrate comprises opaque aluminium foil laminated to paperboard and wherein the security area comprises a lily pad layer to provide adhesion of the full four colour image to the security area.

40. The card as described in claim 1 wherein the substrate comprises opaque aluminium foil laminated to paperboard and wherein the security area comprises a preprint treatment to provide adhesion of the full four colour image to the security area.

41. The card as described in claim 2 wherein the card is a card of a set of scratch-off lottery cards, scratch-off coupons, scratch-off vouchers or scratch-off pre-paid cards, the security area of each card of the set comprising unique information which varies from card to card of the set.

42. The card as described in claim 41 wherein the unique information comprises a portion of the image and wherein an other portion of the image is uniform within the set.

43. The card of the set as described in claim 41 wherein the unique information is integral with the image.

44. An instant scratch-off card, comprising:
(a) a substrate having a security area;
(b) a full colour graphical image printed on the security area comprising variable information variable between cards, the image printed using a digital printing method capable of printing full colour variable images, selected from the group:
(i) the liquid electrophotographic printing method;
(ii) the toner electrophotographic printing method;
(iii) the water based continuous ink jet printing method, and
(iv) the water based drop on demand ink jet printing method;
(c) the security area of the substrate comprising sufficient absorptive qualities to enable a rapid and high level of adhesion of the image to the security area and being sufficiently impenetrable to prevent determination of the contents of the image through the substrate;
(d) at least one varnish layer covering and protecting the image;
(e) at least one scratch off layer covering the at least one varnish layer; and;
wherein the at least one scratch-off layer is sufficiently impenetrable to prevent determination of the contents of the image through the at least one scratch-off layer and wherein the at least one varnish layer facilitates release of the at least one scratch-off layer from the at least one varnish layer when the at least one scratch off layer is removed by a user.
